(19) United States
(12) Patent Application Publication
(10) Pub. No.: US 2013/0298348 A1
(43) Pub. Date: Nov. 14, 2013

(54) ASSEMBLY COMPRISING AN END PIECE OF A WINDSHIELD WIPER ARM AND AN ELECTRICAL CONNECTOR

(71) Applicants: Gérald Caillot, Cernay La Ville (FR); Vincent Izabel, Chilly Mazarin (FR)

(72) Inventors: Gérald Caillot, Cernay La Ville (FR); Vincent Izabel, Chilly Mazarin (FR)

(73) Assignee: VALEO SYSTÈMES D'ESSUYAGE, Le Mesnil Saint Denis (FR)

(21) Appl. No.: 13/989,578

(22) PCT Filed: Sep. 26, 2011
(86) PCT No.: PCT/EP2011/066670

§ 371 Date: Jul. 23, 2013

(30) Foreign Application Priority Data
Dec. 2, 2010 (FR) 1004688

(51) Int. Cl. B60S 1/38

(52) U.S. Cl. CPC B60S 1/3805
USPC 15/250.32

(57) ABSTRACT

The invention relates to an assembly comprising an end piece (2) of a blade holder (1) of a wiper system and an electrical connector (40) intended to connect an electrical network to a blade (3) of the wiper system, the end piece (2) comprising a retaining means (8) that keeps the electrical connector (40) on said end piece (2) when the assembly is in a use position, characterized in that the electrical connector (40) is separated from the end piece (2) when the assembly is in an operating position.

The field of the present invention is that of equipment for vehicles, and more particularly that of equipment for wiping the windshields of automobiles.

Automobiles are routinely equipped with windshield-wiper systems for washing the windshield and preventing disturbance to the driver's view of their environment. These windshield wipers are conventionally driven by a wiper arm effecting an angular to-and-fro movement and include elongate blades carrying squeegees made from a resilient material. These squeegees rub against the windshield and evacuate the water, removing it from the driver's field of view. The blades are produced in the form either, in a conventional version, of articulated swing-arms that hold the squeegee at a number of separate locations or, in a more recent so-called “flat blade” version, a semi-rigid assembly that holds the squeegee over the whole of its length. In the second solution, the blade is attached to the blade-holder by an assembly comprising a mechanical connector and an adapter. The mechanical connector is a part that is crimped directly to the flat blade while the adapter is an intermediate part that enables fixing of the connector to the blade-holder of the windshield wiper. These two parts are connected to each other by a transverse pin that allows their relative rotation in a plane perpendicular to the windshield passing'through the blade-holder.

In designs for top of the range vehicles there are encountered devices for heating the windshield wiper to defrost the wiper in very cold weather and to prevent frost sticking it to the windshield. These devices, which are more specifically suited to flat blades, generally include a heating device integrated into the assembly carrying the squeegee and on which electrical heating elements are deposited. They necessitate an electrical connection device adapted to cooperate with the mechanical connector to transmit to the heating device electrical current coming from the electrical power supply of the vehicle.

The documents WO2009/149917 and WO2010/03444 show embodiments of an electrical connector that supply the mechanical connector with electricity. This electrical connector is permanently connected to the blade-holder and is found to be isostatic relative to the end of the blade-holder.

The electrical connector is therefore connected to the blade-holder and it is necessary to plug it into the mechanical connector when replacing the blade. This operation is generally effected in a so-called servicing position in which the blade is positioned at an angle to the blade-holder by rotation about the transverse pin connecting the mechanical connector to the adapter.

It is necessary to ensure that the electrical connector is correctly aligned when installing it in the mechanical connector, failing which defective assembly would result in a risk of poor electrical contact at the level of the connection of the two connectors. Now, this operation is carried out blind, the electrical connector being situated under the upper part of the blade-holder, which blocks a clear view of the parts to be assembled.

Moreover, it is important for the electrical connector to remain attached to the blade-holder when decoupling or demounting the blade relative to the blade-holder. This prevents the electrical connector from being drawn along with the mechanical connector in its movement separating it from the blade-holder of the windshield wiper. Moreover, it is not acceptable to leave the electrical connector dangling under the end piece of the windshield wiper arm when the blade is demounted.

Finally, on remounting, requiring the operative to hold the electrical connector in position with one hand and to remount the blade on the blade-holder with the other hand cannot be envisaged. Such a situation renders the mounting of the blade particularly difficult and somewhat unergonomic because mounting the blade on the blade-holder already requires the use of both hands, one hand being dedicated to the blade and the other to the windshield wiper arm.

Thus it is important to facilitate insertion and withdrawal of the electrical connector into and from the mechanical connector in such a way that connection and disconnection are effected correctly, even if the operative is inexperienced.

In accordance with another aspect of the prior art, it is known to dispose a windshield wiper blade equipped both with a heating element as described above and a device for spraying a windshield washer liquid.

Such a situation involves the manufacture and use of an electrical connector with a different structure for the blade with a mechanical connector comprising only a heating element compared to the blade with a mechanical connector comprising the heating element and the sprayer device. This represents a logistical inconvenience because it makes it necessary to manage a process for the production of two different electrical connector parts and to hold them in stock.

The object of the present invention is therefore to resolve the drawbacks described above primarily by guaranteeing on the one hand fastening of the electrical connector to the end piece of the windshield wiper arm when the wiper system is in the servicing position and on the other hand releasing of the electrical connector relative to the end piece of the arm when the wiper system is in the operating position.

Another object of the invention lies in the possibility of using an electrical connector of identical structure both for vehicles equipped with wiper blades including only a heating element and for vehicles equipped with wiper blades combining a heating element and a spraying device.

The invention therefore provides an assembly including an end piece of a blade-holder of a wiper system and an electrical connector intended to connect an electrical power supply to a blade of the wiper system, the end piece including retaining means for retaining the electrical connector on said end piece when the assembly is in a servicing position, characterized in that the electrical connector is separated from the end piece when the assembly is in an operating position. Here “separated from” means that there is no direct mechanical connection between the electrical connector, and where applicable its support, and the end piece.

In accordance with a first feature of the invention, the retaining means provide mechanical retention of the electrical connector with respect to the end piece when the assembly is in the servicing position, said retaining means having no contact with the electrical connector when the assembly is in the operating position.

The end piece extends in a first longitudinal direction and the blade extends in a second longitudinal direction, characterized in that the first longitudinal direction is substantially parallel to the second longitudinal direction when the assembly is in the operating position whereas the first longitudinal direction and the second longitudinal direction are oriented at an angle with respect to each other when the assembly is in the servicing position. Here “substantially parallel” refers to the angle between the first longitudinal direction and the second longitudinal direction that results from the curvature of the windshield to be wiped. In accordance with the invention, this angle is between 0° and 8°. The servicing position for its part corresponds to an angle between the first longitudinal direction and the second longitudinal direction between 10° and 20°. This distinguishes the servicing position from the operating position.

In accordance with another feature of the invention, said retaining means comprise at least one part fixed to a lateral face of the end piece and including on its side inside the end piece a cavity adapted to receive a protuberance, for example taking the form of a journal. Alternatively, the lateral face of the end piece may be conformed to delimit a cavity to receive the protruberance.

In accordance with a further feature of the invention, the retaining means retain the electrical connector on the end piece indirectly when the assembly is in the servicing position.

In accordance with a further feature of the invention, a support is disposed between the retaining means and the electrical connector, the protuberance being a part of said support.

Alternatively, the retaining means retain the electrical connector on the end piece directly when the assembly is in the servicing position, said protuberance being a part of said electrical connector.

The wiper system advantageously further includes a mechanical connector fixed to said blade to attach it to the end piece of the blade-holder, said assembly including guide means adapted to cooperate with a corresponding element of the mechanical connector to align the electrical connector with the mechanical connector on passing from the servicing position to the operating position.

The guide means are advantageously positioned laterally with respect to the electrical connector, in particular laterally with respect to the support.

The element is advantageously a guide ramp on the mechanical connector, advantageously on a lateral face thereof.

In accordance with one feature of the invention, the assembly includes means for locking the electrical connector with respect to the mechanical connector.

In accordance with another feature of the invention, the locking means are a part of a support that is inserted between the retaining means and the electrical connector.

Finally, the invention provides a wiper system for vehicles, notably automobiles, including a blade-holder driving a blade equipped with a mechanical connector connected to each other by an assembly as envisaged above.

A first advantage of the invention lies in the possibility of offering particularly ergonomic mounting of a blade on a blade-holder of a wiper system. An inexperienced person can therefore easily carry out an operation of replacing a windshield wiper blade equipped with a heating element without concerning themselves with the alignment and the electrical connection at the level of the end piece of the blade-holder.

Another, non-negligible advantage lies in the standardization of the electrical connector, as identical connectors can be used in the case of a wiper system with only a heated blade and in the case of a wiper system with a heated blade and an integrated spraying device.

Other features, details and advantages of the invention will become more clearly apparent on reading the description given hereinafter by way of illustration and with reference to the drawings, in which:

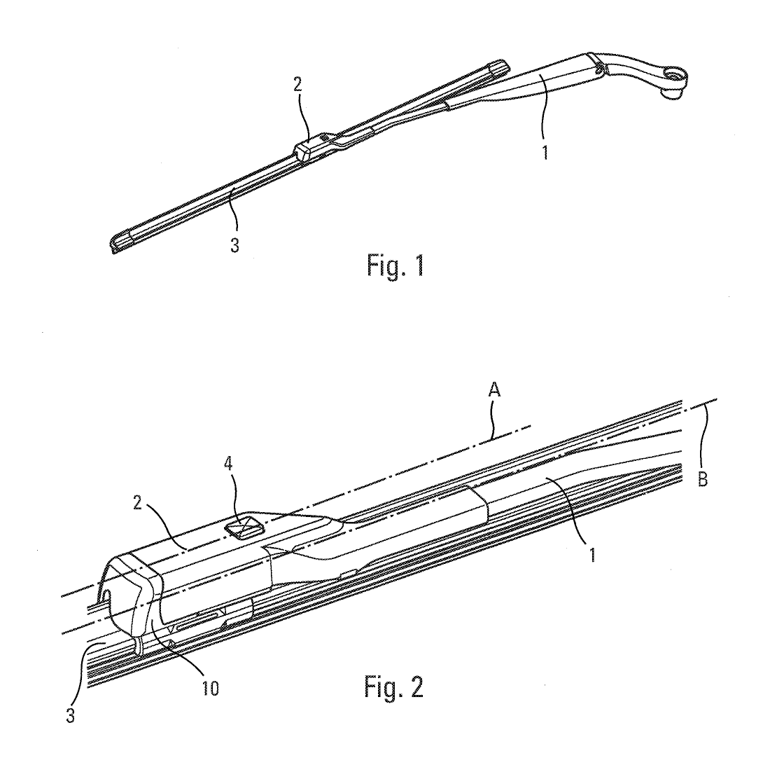

FIG. 1 is a general perspective view of a wiper system for a windshield of an automobile vehicle;

FIG. 2 is a view of a detail from FIG. 1 showing the connection between the blade-holder and the blade of the windshield wiper;

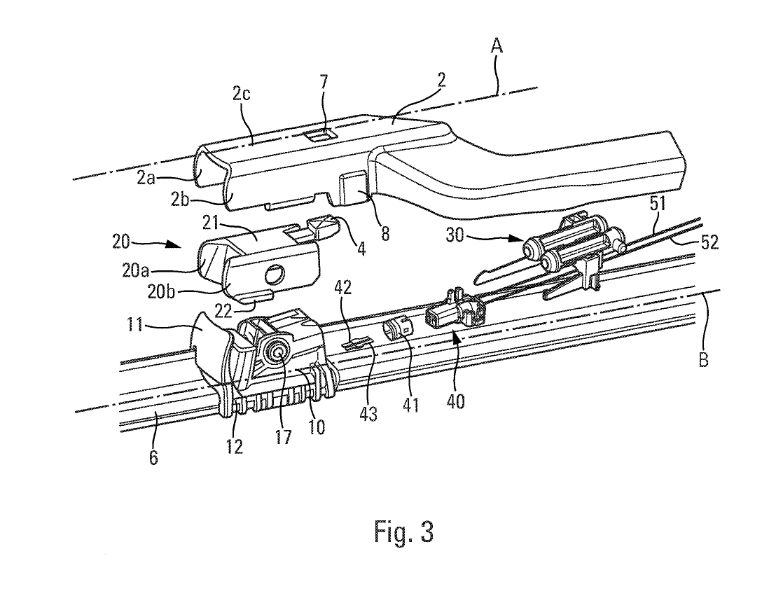

FIG. 3 is an exploded view of a windshield wiper including an assembly in accordance with the invention;

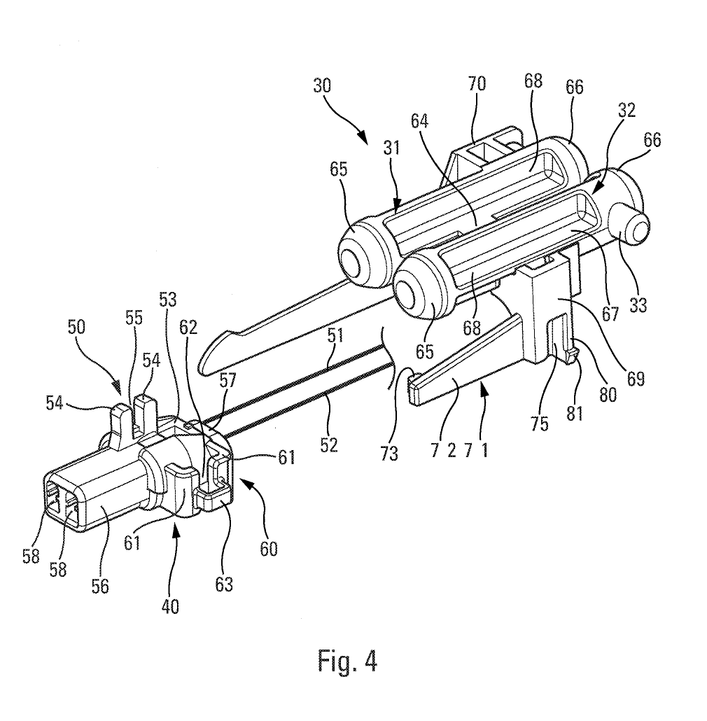

FIG. 4 is a perspective view of an electrical connector and its support in accordance with one embodiment of the invention;

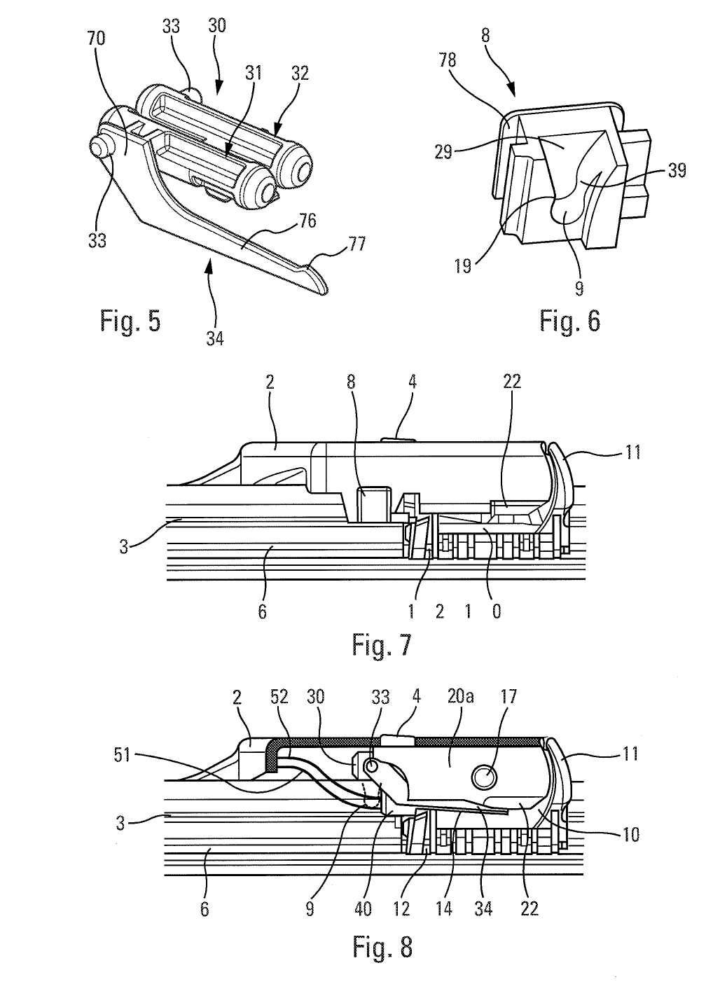

FIG. 5 is a perspective view of the support used by the assembly in accordance with one embodiment of the invention;

FIG. 6 is a perspective view of means for retaining the electrical connector or the support from FIG. 4;

FIG. 7 is a lateral view of a connection from FIG. 2 with the windshield wiper in an operating position;

FIG. 8 is a view in partial section of the connection from FIG. 7;

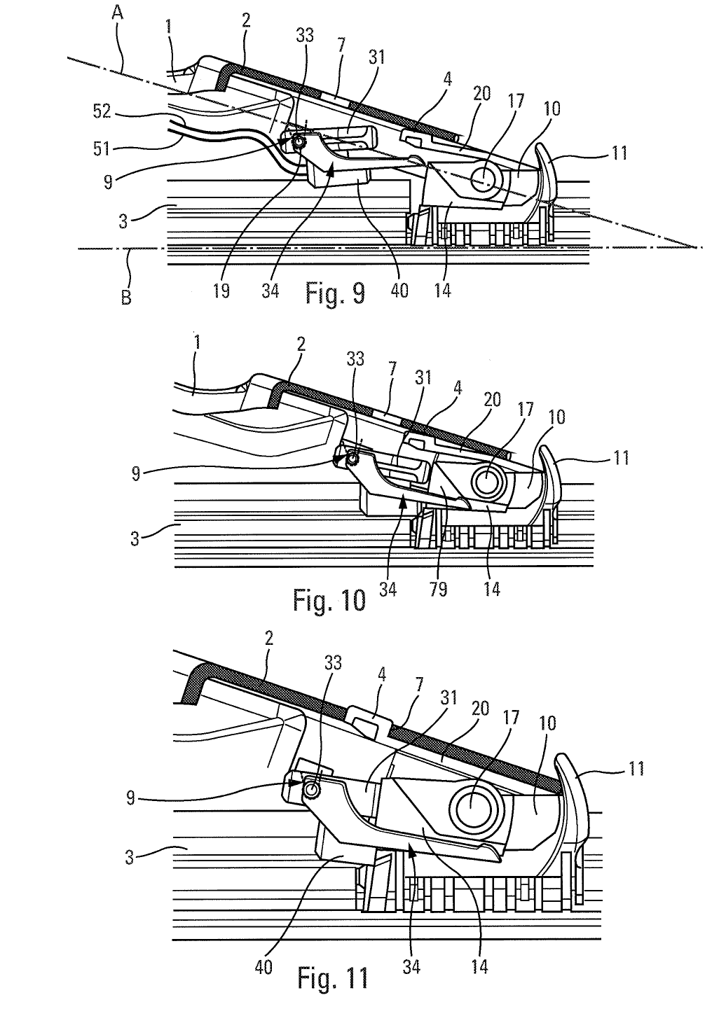

FIGS. 9 to 11 are sequential views of a windshield wiper of the invention showing in detail the transition of the wiper system in accordance with the invention between the servicing position and the operating position.

It should be noted that the figures disclose the invention in detail for the purposes of practising the invention and that said figures may of course where necessary serve to define the invention more clearly.

In the remainder of the description, the terms longitudinal or lateral refer to the orientation of the blade-holder on which the windshield wiper blade is mounted. The longitudinal direction corresponds to the main axis of the blade-holder, in which it extends, while the lateral orientations correspond to straight line segments that cross the longitudinal direction, notably perpendicular to the longitudinal axis of the blade-holder in its rotation plane. For the longitudinal directions, the terms exterior or interior are to be understood relative to the point at which the blade is fixed to the blade-holder, the term interior corresponding to the portion in which the blade-holder and a half-blade lie. Finally, the directions referred to as upper or lower correspond to orientations perpendicular to the rotation plane of the blade-holder, the term lower containing the plane of the windshield.

Referring to FIGS. 1 and 2, there is seen a wiper system composed of an arm or blade-holder 1 extended at its exterior end by an end piece 2 that is fixed, for example crimped, to the interior side of the blade-holder 1. The end piece 2 covers an adapter carrying the blade 3 by way of a mechanical connector 10. The function of the adapter is to be inserted in the end piece 2 by movement of the end piece 2 in translation in a first longitudinal direction A to arrive at the position of use, otherwise referred to as the operating position, in which it is abutted against a cooperating shape imparted to the end piece 2. It is then fixed in reversible fashion by means of a retractable locking button 4 that cooperates with an orifice provided for this purpose in the upper part of the end piece. The blade extends longitudinally in a second longitudinal direction B.

Referring now to FIG. 3, the elements for attaching the blade 3 to the blade-holder 1 are seen in detail.

The end piece 2 has an inverted “U” shape with the open end of this “U” shape facing the windshield. This end piece 2 includes a base 2c in the upper part and two lateral branches 2a and 2b extending in the direction of the windshield. In the base 2c there is an orifice 7 in which the retractable locking button 4 that is a part of the adapter 20 is accommodated. The lower edge of each lateral branch includes a rim bent at 90° in the direction of the internal volume defined by the base 2c and the branches 2a and 2b, the function of which rim is on the one hand to guide longitudinally the introduction of the adapter 20 and on the other hand to serve as an abutment for movement in translation to corresponding abutments placed on the adapter 20. To at least one of the lateral branches 2a and/or 2b of the end piece 2 are fixed retaining means the function of which is to retain the electrical connector either directly or indirectly via a support 30. The retaining means 8 block movement in translation of the electrical connector 40 on withdrawing the blade 3 to retain it in the internal volume of the end piece 2, which will be described in detail later. Each of the lateral branches 2a and 2b of the end piece 2 advantageously has retaining means 8 fastened to it. In such a situation the end piece 2 includes two retaining means 8 disposed opposite each other.

The adapter 20 takes the form of a yoke complementary to the internal volume of the end piece 2 so that it can be accommodated in the latter. Two lateral walls 20a and 20b are joined by a bridge 21 and each has at its free edge a rim 22 bent toward the outside of the adapter. These rims 22 form an abutment for movement in translation when they come to bear against the bent over rims of the lateral branches of the end piece 2. This adapter 20 also includes two coaxial holes produced through the lateral walls 20a and 20b to serve as rotation axis between the blade 3 and the blade-holder 1 enabling free rotation between the blade-holder 1 and the blade 3 when the wiper system is effecting to-and-fro movements. This enables the blade 3 to follow the curvature of the windshield to be wiped.

The mechanical connector 10 is permanently fastened to the blade 3 so as to transmit the mechanical force from the blade-holder 1 to the blade 3. It is substantially parallelepiped-shaped and extends in the second longitudinal direction B of the blade 3 with two lateral flanks from which extend laterally two journals or a shaft 17 the functions of which are on the one hand to fasten the mechanical connector to the adapter 20 and on the other hand, by cooperating with the holes produced in the lateral walls 20a and 20b of the adapter, to enable rotation of the blade 3 relative to the blade-holder 1.

On the exterior side, the mechanical connector has a wall 11, called the cap, which firstly closes the front part of the end piece 2 and serves as a screen to protect the components contained inside this end piece 2 and secondly provides a quality exterior finish. The face of the mechanical connector 10 opposite the cap 11, called the lower face, includes electrical connection orifices (not visible) adapted to receive the electrical connector 40.

This interior face of the mechanical connector 10 further includes one or more hydraulic inlet orifices extended by internal channels for distributing the windshield washing liquid. These distribution channels (not represented in the figures) extend inside the mechanical connector 10 and discharge in line with feed pipes 12 formed in the mechanical connector 10 and thus supply spray tubes 6 through which the blade sprays the liquid. These tubes extend along the two edges of the blade 3 in order to spray the windshield washing liquid during the to-and-fro movement of the blade. These features relating to spraying windshield washing liquid are referred to overall as a windshield washing liquid spraying device if the windshield wiper blade is connected to a windshield washing liquid spraying system.

The hydraulic inlet orifices delimit channels inside the mechanical connector, these channels also having the function of accepting the support 30 to retain it in position in the mechanical connector 10.

The electrical connection orifices delimit conduits inside the mechanical connector 10, these conduits having the function of receiving the electrical connector 40 and providing the electrical connection between the electrical power supply of the vehicle and the blade 3.

These internal conduits contain male plugs 42 and 43 onto which are pushed female terminals carried by the electrical connector 40. This electrical connection supplies the electrical power necessary for the operation of the heating element integrated into the blade. Of course, the invention covers the situation where the male plugs are part of the electrical connector 40, cooperating with female terminals installed in the internal conduit or conduits formed in the mechanical connector 10.

The electrical connector 40 is secured on the end piece 2 the retaining means 8. In other words, the retaining means guarantee a mechanical connection between the electrical connector 40 and the end piece 2 as a function of the position of the blade 3 relative to the end piece 2, and more generally relative to the blade-holder 1. This connection between the electrical connector 40 and the end piece 2 is not isostatic. In fact, for reasons that will be explained later, it allows movement, notably rotation.

This electrical connector 40 receives two electrical cables 51 and 52 carrying electrical current from the electrical power supply of the vehicle. These cables 51 and 52 are joined together to form a harness that extends inside the internal volume of the end piece 2 and under the blade-holder.

The electrical connector 40 also receives a sealing device 41 threaded onto the body. This sealing device seals the electrical connection between the electrical connector 40 and the mechanical connector 10.

In one embodiment of the invention the electrical connector 40 is retained relative to the end piece 2 directly, i.e. with no intermediate part other than the retaining means 8.

The invention also encompasses another embodiment in which the electrical connector 40 is connected to the end piece indirectly, i.e. by means of at least one intermediate part 30 called a support. In this embodiment, the support 30 is disposed between the electrical connector 40 and the retaining means 8 and the electrical connector 40 is fastened to the support by connecting means that cooperate with shapes produced on the support 30. For its part, the support is connected to the end piece 2 by the retaining means 8.

The structure that will be described hereinafter with reference to the support 30 is transposable to the electrical connector itself when the assembly in accordance with the invention does not include a support, i.e. the variant in which the electrical connector is retained on the end piece directly (by way of the retaining means, where applicable).

As represented in FIG. 4, the electrical connector 40 includes a body 53 molded from a plastic material. The connecting means comprise locking means 50 and clipping means 60. The locking means 50 are part of this body 53 and take the form of two pegs 54 that project from the periphery of the body 53. Between the two pegs 54 there is a slot 55 in which a complementary edge that is part of the support 30 is inserted.

The clipping means 60 comprise two L-shaped branches 61 each of which is part of a connecting part 57 of the body 53. Between this connecting part 57 and these two branches 61 there is a housing 62 that is intended to receive a rib 80 that is part of the support 30. The free end of these two branches 61 supports a U-shaped hook 63 that serves to lock the rib 80 by locking a tooth 81 at the free end of the rib 80 in order to lock the electrical connector relative to the support.

It is seen that the locking means 50 are produced centrally with respect to the electrical connector 40 and with respect to the support 30 while the clipping means 60 are installed laterally on these same components. Such an arrangement has the advantage that the connecting means provide perfect mechanical retention despite the presence of a deflector on one side of the blade-holder.

The body 53 comprises two subassemblies: an insertion part 56 and the connecting part 57.

The insertion part 56 has a rectangular external section that is inserted in the internal conduit or conduits in the mechanical connector. This insertion part further includes two internal recesses 58 in the form of tubular conduits in which the electrical terminals, for example the female terminals, lie. The latter terminals are thus connected to the internal electrical circuit of the mechanical connector 10, which passes through it to reach the heating elements of the squeegee of the blade.

These recesses 58 continue as far as the connecting part 57 where the male or female terminals are connected to the electrical cables 51 and 52.

In an alternative form of these connecting means, the connecting part 57 of the electrical connector 40 is inserted by movement in translation into attachment means (not represented) on the support 30. The attachment means comprise for example a hoop or an arch closing onto the lower face of the support 30 and into which is inserted the body 53 of the electrical connector 40, in particular its connecting part 57.

It is seen that in this variant with a support the electrical connector 40 is carried by the support 30 and fixed to it before installing the assembly in accordance with the invention on the mechanical connector 10.

It is therefore clear that the electrical connector 10 may comprise either one and only one connecting means 50 or 60 or a plurality of separate connecting means. Accordingly, the same electrical connector 10 including a plurality of connecting means may be used for fixing it to different objects such as a support of the invention, a support with a different structure employed for another application or a wiper system hydraulic connector through which a windshield washing liquid flows.

The support 30 takes the form of two parallel tubular sectors 31 and 32 disposed longitudinally and mechanically connected to each other by at least one connecting bridge 64, the latter bridge including an edge (not visible in this figure) intended to occupy the slot 55 of the electrical connector and thereby to fix the latter to the support 30.

For example, the tubular sectors 31 and 32 take the form of a solid tube of cylindrical section, the direction in which these sectors extend being defined by a straight line segment centered in the cylindrical section.

Each of these sectors 31 or 32 has a first end 65 and a second end 66 on the opposite side of a base 67 to the first end 65. This base 67 has a cruciform section such that voids 68 are produced, notably four voids distributed peripherally around the base 67. Such a structure offers good mechanical strength whilst using a small quantity of material to produce the support 30.

The first end.65 of each sector 31 or 32 includes a chamfer that facilitates insertion of the support 30 into the hydraulic orifices of the mechanical connector.

Laterally, the support 30 includes two protruberances in the form of journals that are a part of the sectors 31 an 32 and form a shaft the length of which is close to the width of the end piece 2. These protruberances 33 are formed by a circular section tube that extends along an axis perpendicular to a direction in which the tubular sector of which the protuberance is a part extends.

The support 30 also has two lateral faces 69 and 70 each of which is a part of a tubular sector 31 or 32. Locking means 71 are provided on one of the lateral faces of the support 30, here the lateral face 69. By means of the support 30, for example, these locking means 71 lock the electrical connector 40 against movement relative to the mechanical connector in translation along an axis parallel to the direction in which the tubular sections 31 and 32 extend.

These locking means 71 include an elongate tongue 72 molded onto the lateral face 69. The free end of this tongue 72 includes a tooth 73 intended to hook over an edge formed on the mechanical connector. To be more precise, this tooth 73 is formed on an internal face of the elongate tongue 72 in the vicinity of an edge surface of the tongue forming the free end.

The lateral face 69 further includes a cut-out 75, corresponding to rectilinear removal of material, the function of which is to allow the passage of one of the branches 61 that is a part of the body 53 forming the electrical connector 40. The cut-out 75 delimits on the lateral face 69 the rib 80 for blocking movement in translation between the electrical connector 40 and the support 30.

FIG. 5 shows the support 30 seen from the side opposite that seen in FIG. 4. The lateral side 70 is therefore visible.

The support 30 includes guide means 34 intended to cooperate with a corresponding element of the mechanical connector. The effect of this cooperation is to align the electrical connector with the mechanical connector during movement from the servicing position to the operating position.

These guide means 34 extend laterally relative to the support 30 in the direction of the mechanical connector with which it is to cooperate when mounting the blade 3 on the blade-holder 1.

The two tubular sectors 31 and 32 are parallel and connected to each other to form a one-piece part, advantageously produced in plastic. The two protruberances or journals 33 extend perpendicularly to the lateral faces 69 and 70 on either side of the angular sectors 31 and 32 and molded in one piece with these sectors. As a general rule, each protruberance 33 protrudes perpendicularly to the sector that supports it.

The lateral face 70 is extended downward and toward the front so as to form the guide means 34 intended to be integrated into a guide ramp provided for this purpose and formed in a lateral face of the mechanical connector. This guide ramp thus forms the corresponding element on the mechanical connector with which the guide arm cooperates. In practice, the guide means are formed by an arm 76 that extends in a direction parallel to the direction in which the tubular sectors 31 and 32 extend. It will further be noted that the free end of the arm 76 projects beyond an exterior end of the immediately adjacent sector 31. The arm is longer than the passage of which it is a part. The free end of the arm 76 further includes a rib 77 formed by an enlargement of the end of the arm 76. This rib 77 has at least one inclined edge that facilitates insertion of the arm into the ramp.

FIG. 6 shows the details of one embodiment of the retaining means 8, as seen from inside the end piece 2. It takes the form of a parallelepiped contained between an external face and an internal face, these two faces being at a distance from each other at least equal to the thickness of a lateral face of the end piece 2.

These retaining means 8 include a cut-out 78 that is disposed longitudinally with respect to a lateral face of the parallelepiped. This cut-out 78 forms a slide into which is integrated the thickness of the lateral face 2a or 2b on which the retaining means 8 are mounted. The parallelepiped is extended toward the inside of the end piece 2 by a cavity 9 of so-called keyhole shape. In other words, the section of the cavity is the shape of an “Ω”.

A cylindrical lower portion 19 of said cavity 9 has the shape of a hollow circular cylinder extending perpendicularly to the external and internal faces of the parallelepiped while the upper part 29 is flared in a “V” shape. The two parts are joined to form a bottleneck 39 having an aperture substantially equal to the diameter of the protruberances 33 of the electrical connector 40 or the support 30, depending on the embodiment chosen. This is to create a hard spot when engaging the protruberances 33 in the cylindrical part of the cavity 9 and thereafter to prevent unintentional escape of these protruberances once the blade has been placed in the servicing position.

Alternatively, the cavity 9 and the features relating to this cavity may be formed directly on the lateral wall or walls 2a or 2b by deformation of the face of these walls facing toward the inside of the end piece 2.

Referring now to FIGS. 7 and 8, there is seen the blade 3 mounted on the blade-holder, in the position of use otherwise called the operating position, respectively in front view and in partial section on the end piece 2 so as to show the mechanical connector 10, the adapter 20, the electrical connector 40 and the support 30.

In this position, the tubular sectors 31 and 32 of the support 30 are inserted in internal channels of the mechanical connector 10, the latter channels being delimited on the interior face of the mechanical connector by the hydraulic orifices. The arm, forming one embodiment of the guide means 34, has entered entirely inside the guide ramp 14 of the mechanical connector 10. The electrical connector 40 is for its part fastened to the support 30 by the connecting means and inserted in the mechanical connector 10. This makes the electrical connection between the electrical power supply of the vehicle, via the electrical cables 51 and 52, and the heating element or elements mounted on the blade 3.

The locking means also block movement in translation of the support. This renders secure the electrical connection between the support 30 and the mechanical connector 10 when the assembly in accordance with the invention is in the operating position.

In FIG. 8 there is also seen, in thin line, the position of the cavity 9 relative to the protruberance 33. It is situated at the bottom because of the closing of the end piece 2 onto the mechanical connector 10. It therefore does not interfere with the protruberance 33 of the support 30, which enables release of all mechanical retention between the support 30 and the end piece 2. In other words, the electrical connector 40, and in an accessory way its support 30, are not attached to the end piece 2 and can freely follow the movement of the blade when the latter wipes the windshield of the vehicle. It is clear from this that the electrical connector 40 is separated from the end piece 2 when the assembly in accordance with the invention is in the operating position. To be more precise, the electrical connector 40, and where applicable the support 30, therefore do not touch the end piece 2. There is therefore no direct physical contact between the retaining means 8 and the electrical connector 40 or where applicable the support 30.

FIGS. 9 to 11 show, in sequence, the mounting of a support 30 in accordance with the invention in a mechanical connector 10 having an appropriate guide ramp 14, i.e. one formed by removing material from one of the flanks of the mechanical connector 10.

In the three figures, the blade-holder 1 is in the servicing position, i.e. the second longitudinal direction B of the blade 3 is at an angle to the first longitudinal direction A of the blade-holder, and more particularly of the end piece 2. In other words, the second longitudinal direction B of the blade 3 and the first longitudinal direction A of the blade-holder are different and concurrent.

The end piece 2 of the blade-holder 1 and the adapter are represented in section to show the electrical connector 40, the support 30 and the mechanical connector 10. The support 30 is attached to the end piece 2, its protruberances 33 being positioned in the cylindrical parts 19 of the two retaining means 8 situated on either side of the end piece 2 when the latter is provided with same. In this situation, the support 30, and in a correlated way the electrical connector 40, are retained by the end piece 2 of the blade-holder 1.

The adapter 20 is represented in FIG. 9 at the start of its movement of introduction into the end piece 2, while in FIGS. 10 and 11 it is respectively represented in the middle and then at the end of this movement. This movement illustrates the installation of the blade 3 on the blade-holder 1.

In FIG. 9, the arm 76 of the support 30 is seen in isolation, the electrical connector being held by the retaining means 8, via the support 30, whilst being free to turn about an axis passing through at least one protruberance 33, advantageously both protruberances 33. The electrical connector 40 is of course connected to the electrical cables 51 and 52.

In FIG. 10, the arm 76 forming the guide means 34 has been engaged in the guide ramp 14 present on the lateral face of the mechanical connector 10. The guide means 34 have therefore obliged the electrical connector to rotate about the axis passing through the protruberance 33, in a vertical plane, to follow the orientation imposed by this ramp. It will be noted that the introduction of the arm 76 into the ramp 14 is facilitated by the presence of a flared sector 79 at the level of an introductory part of the ramp. In other words, the guide ramp 14 includes an entry sector 79 that has a flared section.

In the angular position shown in FIG. 10, the tubular sectors 31 and 32 are aligned with the axis of the internal channels of the mechanical connector 10 because the arm 76 is now situated in a rectilinear sector of the guide ramp 14. The latter ramp is formed by the entry sector 79 followed by a rectilinear sector that extends along an axis parallel to the direction in which the internal channel or each internal channel of the mechanical connector 10 extends, these channels being windshield washing liquid feed channels, for example.

In FIG. 11, the adapter 20 is at the end of its travel on the end piece 2. The guide means 34 are completely inserted in the guide ramp 14 and the retractable locking button 4 is located in the orifice 7. This completes the introduction of the electrical connector 40 into the internal conduit or conduits of the mechanical connector 10, with the tubular sectors 31 and 32 of the support 30 installed in the internal channels of the mechanical connector 10.

The assembly in accordance with the invention can then be moved from its servicing position as shown in FIGS. 9 to 11 to its operating position as shown in FIGS. 7 and 8. The rotation of the blade 3 relative to the end piece 2 about the axis passing through the shaft 17 causes disengagement of the protruberances 33 relative to the retaining means 8.

There will now be described the replacement of a blade on a blade-holder of a wiper system including an assembly in accordance with the invention, comprising demounting the worn blade and replacing it with a new blade.

The operative begins by placing the blade 3 in the servicing position, inclining it at an angle between 5° and 25° relative to the second longitudinal direction of the blade-holder 1. In doing so, they cause the protruberances 33 of the support 30 to enter into the retaining means 8, notably into the cylindrical parts 19 of the cavities 9 of the parallelepipeds fixed to each of the two lateral faces 2a and 2b of the end piece 2. The support 30 is then retained longitudinally in position by these retaining means but remains free to rotate about the axis passing through these protuberances.

This movement from the operating position to the servicing position also causes the blade 3 to turn relative to the adapter 20, which remains aligned with the end piece 2 on which it is mounted. Thanks to the flexibility of the elongate tongue 72, there then follows unlocking of the locking means 71 by releasing the tooth 73. This allows relative longitudinal movement or movement in translation between the electrical connector 40 and the mechanical connector 10 after unfastening the adapter 20 from the end piece 2.

This unfastening is effected by depressing the retractable locking button 4 to cause it to exit the orifice 7. The operative can slide the adapter 20 in the slideways formed by the bent edges of the lateral faces 2a and 2b of the end piece 2, either by pulling on the adapter 20 or by pulling on the mechanical connector 10, until the blade 3 is completely unfastened with respect to the blade-holder 1.

The mounting of a new blade is effected in the reverse direction, beginning with opening of the adapter 20 to place it at an angle to the mechanical connector 10. Mounting is carried out when the assembly in accordance with the invention is in the servicing position. Mounting continues with alignment of the adapter 20 on the end piece 2 followed by its insertion into the end piece 2 until the rims 22 come up against the abutments on the lateral faces 2a and 2b of the end piece.

During this maneuver in translation, the mechanical connector 10 gradually approaches the electrical connector 40, notably the support 30, and the arm 76 forming the guide means 34 enters into the guide ramp of the mechanical connector 10, this entry being facilitated by the presence of the flared sector 79. As the arm 76 is inserted into the ramp 14, it causes the electrical connector 40, and notably the support 30, to turn about the axis passing through the protruberances 33, to move it into an angular position in which the insertion part of the electrical connector is aligned with the internal electrical conduit of the mechanical connector. The tubular sectors 31 and 32 are aligned with the internal channels of the mechanical connector 10.

On continuing to push the mechanical connector 10 and the adapter 20 against the end piece 2, the tubular sectors 31 and 32 are inserted into the internal channels of the mechanical connector and fix the support. In doing this, the electrical connector 40 penetrates into the mechanical connector to provide the electrical connection of the blade to the electrical power supply of the vehicle.

Then, by bringing the blade 3 back against the blade-holder 1, i.e. on moving from the servicing position to the operating position, the descent of the end piece 2 against the mechanical connector 10 leads to the protruberance 33 exiting the cavity 9 in which it was enclosed. The support is then no longer fastened to the end piece 2 and is able to follow the movements of the mechanical connector relative to the blade-holder when wiping the windshield.

The invention has been described for a windshield wiper blade of the flat blade type with a mechanical connector comprising two internal channels and a support comprising two tubular sectors. It is obvious that, without departing from the scope of the invention, it can equally well be employed in the case of a support including only one tubular sector.

The invention described above shows the arm 76 as part of the support 60 or the electrical connector 40 that cooperates with a ramp-forming element 14 produced on the mechanical connector 10. It goes without saying that the invention also covers a reverse situation in which the guide means 34, for example the arm 76, is a part of the mechanical connector 10 so as to cooperate with a corresponding element, notably a ramp 14, on the support 30, for example on at least one of its lateral faces.

This latter variant has a non-negligible advantage. In fact, the support is a part that remains on the vehicle throughout its service life. It is therefore not intended to be replaced each time the wiper blade is changed, as is the case with the mechanical connector. It is thus advantageous to form the ramp on the support because this component is formed inside the volume delimited by the support. This avoids having a protruberance formed by the arm that projects from this volume with the risk of it being broken by repeated consecutive manipulations on mounting and demounting the wiper blade. In a correlated way, it is advantageous to place this arm on the mechanical connector connected to the blade because this mechanical connector is replaced each time the blade is changed. The arm is therefore new each time the blade is changed, which guarantees correct alignment on the support of the mechanical connector each time the blade is changed.

1. An assembly comprising:
an end piece of a blade-holder of a wiper system; and
an electrical connector intended to connect an electrical power supply to a blade of the wiper system, the end piece including retaining means for retaining the electrical connector on said end piece when the assembly is in a servicing position,
wherein the electrical connector is separated from the end piece when the assembly is in an operating position.

2. The assembly as claimed in claim 1, wherein the retaining means provide mechanical retention of the electrical connector with respect to the end piece when the assembly is in the servicing position, said retaining means having no contact with the electrical connector when the assembly is in the operating position.

3. The assembly as claimed in claim 1, wherein the end piece extends in a first longitudinal direction and the blade extends in a second longitudinal direction, wherein the first longitudinal direction is substantially parallel to the second longitudinal direction when the assembly is in the operating position whereas the first longitudinal direction and the second longitudinal direction are oriented at an angle with respect to each other when the assembly is in the servicing position.

4. The assembly as claimed in claim 1, wherein said retaining means comprise at least one part fixed to a lateral face of the end piece and including on a side inside the end piece a cavity adapted to receive a protruberance.

5. The assembly as claimed in claim 4, wherein the retaining means retain the electrical connector on the end piece indirectly when the assembly is in the servicing position.

6. The assembly as claimed in claim 5, wherein a support is disposed between the retaining means and the electrical connector, the journal protruberance being a part of said support.

7. The assembly as claimed in claim 4, wherein the retaining means retain the electrical connector on the end piece directly when the assembly is in the servicing position, said protruberance being a part of said electrical connector.

8. The assembly as claimed in claim 1, wherein the wiper system further includes a mechanical connector fixed to said blade to attach the blade to the end piece of the blade-holder, said assembly including guide means adapted to cooperate with a corresponding element of the mechanical connector to align the electrical connector with the mechanical connector on passing from the servicing position to the operating position.

9. The assembly as claimed in claim 8, wherein the guide means are positioned laterally with respect to the electrical connector.

10. The assembly as claimed in claim 8, wherein the element is a guide ramp on the mechanical connector, on a lateral face thereof.

11. The assembly as claimed in claim 8, wherein means are provided for locking the electrical connector with respect to the mechanical connector.

12. The assembly as claimed in claim 11, wherein the locking means are a part of a support that is inserted between the retaining means and the electrical connector.

13. A wiper system for vehicles, including an assembly as claimed in claim 1.
